(19) United States
(12) Patent Application Publication
(10) Pub. No.: US 2026/0071617 A1
(43) Pub. Date: Mar. 12, 2026

(54) CRYOPUMP AND CONTROL DEVICE

(71) Applicant: SUMITOMO HEAVY INDUSTRIES, LTD., Tokyo (JP)

(72) Inventor: Shuuhei GOTANDA, Tokyo (JP)

(73) Assignee: SUMITOMO HEAVY INDUSTRIES, LTD., Tokyo (JP)

(21) Appl. No.: 19/321,090

(22) Filed: Sep. 5, 2025

(30) Foreign Application Priority Data
Sep. 9, 2024 (JP) 2024-155359

(51) Int. Cl. F04B 37/08; F04B 39/00; F04B 49/06; H02P 29/50

(52) U.S. Cl. CPC F04B 37/08; F04B 39/0027; F04B 49/06; H02P 29/50

(57) ABSTRACT

A cryopump includes a cold head motor, an inverter that is disposed remotely from the cold head motor and is configured to output a PWM voltage for driving the cold head motor at a determined operation frequency, and at least one converter that is connected between the inverter and the cold head motor, the at least one converter being configured to receive the PWM voltage from the inverter, convert the PWM voltage into a cold head motor drive voltage for driving the cold head motor at the determined operation frequency, and output the cold head motor drive voltage to the cold head motor, in which the cold head motor drive voltage has a waveform in which a radio frequency component is reduced as compared with the PWM voltage.

### CROSS-REFERENCE TO RELATED APPLICATIONS

This application claims priority to Japanese Patent Application No. 2024-155359, filed on September 9, 2024, which is incorporated by reference herein in its entirety.

### BACKGROUND

### TECHNICAL FIELD

A certain embodiment of the present invention relates to a cryopump and a control device.

### DESCRIPTION OF RELATED ART

A cryopump is a vacuum pump that captures gas molecules on a cryopanel cooled to a cryogenic temperature by condensation or adsorption to exhaust the gas molecules. For example, the cryopump is installed in a vacuum chamber of a vacuum process device or other vacuum devices to provide a vacuum environment in the vacuum chamber.

### SUMMARY

According to an embodiment of the present invention, there is provided a cryopump including: a cold head motor, an inverter that is disposed remotely from the cold head motor and is configured to output a pulse width modulation (PWM) voltage for driving the cold head motor at a determined operation frequency; and at least one converter connected between the inverter and the cold head motor. The converter is configured to receive the PWM voltage from the inverter, convert the PWM voltage into a cold head motor drive voltage for driving the cold head motor at the determined operation frequency, and output the cold head motor drive voltage to the cold head motor. The cold head motor drive voltage has a waveform in which a radio frequency component is reduced as compared with the PWM voltage.

According to another embodiment of the present invention, there is provided a control device including: an inverter that is disposed remotely from a cold head motor and is configured to output a PWM voltage for driving the cold head motor at a determined operation frequency; and at least one converter connected between the inverter and the cold head motor. The converter is configured to receive the PWM voltage from the inverter, convert the PWM voltage into a cold head motor drive voltage for driving the cold head motor at the determined operation frequency, and output the cold head motor drive voltage to the cold head motor. The cold head motor drive voltage has a waveform in which a radio frequency component is reduced as compared with the PWM voltage.

### BRIEF DESCRIPTION OF THE DRAWINGS

FIG. 1 is a schematic view illustrating a cryopump according to an embodiment.

FIG. 2 is a view schematically illustrating an example of a control output from an inverter to a cold head motor according to the embodiment.

FIG. 3 is a view schematically illustrating a part of a control device of the cryopump according to the embodiment.

FIG. 4 is a view schematically illustrating a part of the control device of the cryopump according to the embodiment.

### DETAILED DESCRIPTION

The cryopump may be mounted on a vacuum device that can generate radioactive rays, for example, an accelerator. The radioactive rays may have an adverse effect such as malfunction or damage on a cryopump, for example, a control device of the cryopump. It is desirable to adapt a cryopump to a radiation environment. According to the present invention, the cryopump can be adapted to the radiation environment. Hereinafter, an embodiment for carrying out the present invention will be described in detail with reference to the drawings. In the description and the drawings, the same or equivalent components, members, and processes will be represented by the same reference numerals, and redundant description will be omitted as appropriate. A scale and a shape of each of portions shown in the drawings are set for convenience to make the description easy to understand, and are not to be interpreted as limiting unless otherwise stated. The embodiment is merely an example and does not limit the scope of the present invention. All features or combinations thereof described in the embodiment are not essential to the invention.

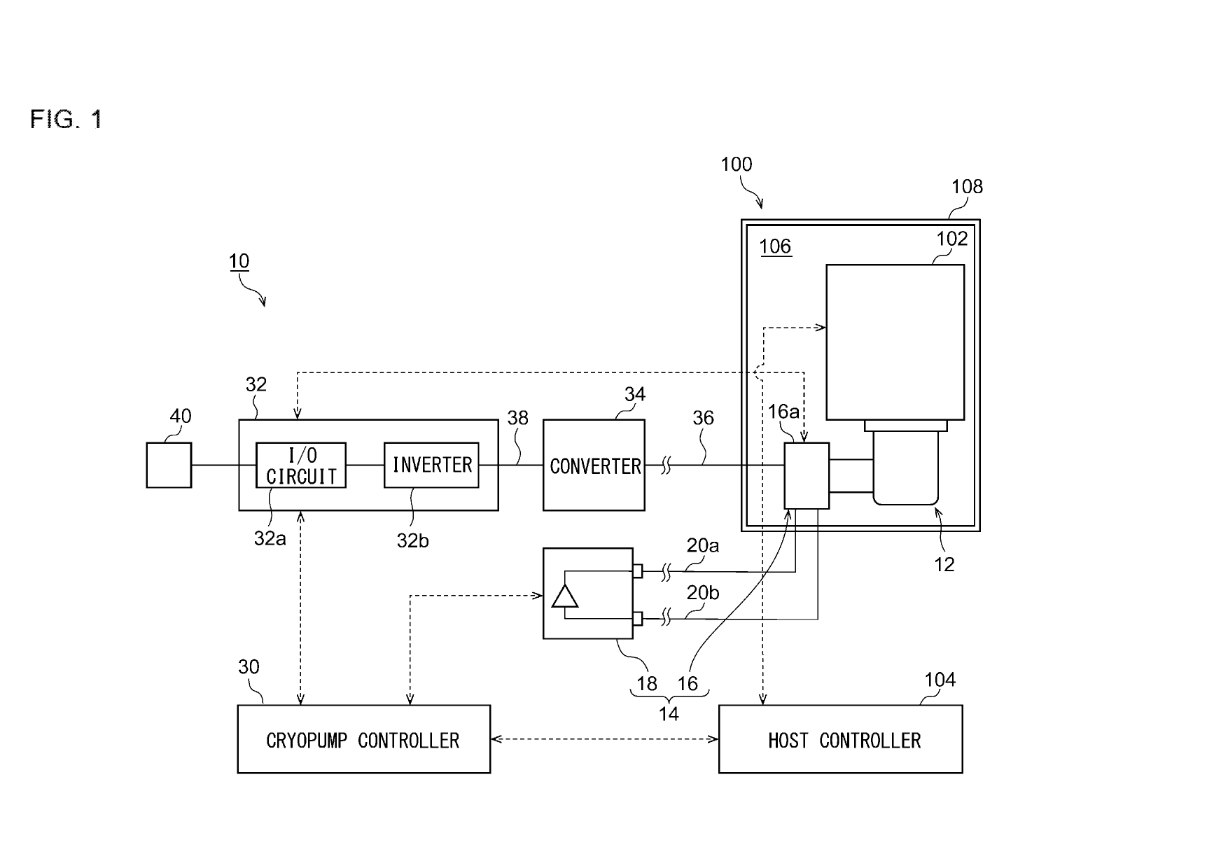

FIG. 1 is a schematic view illustrating a cryopump 10 according to the embodiment. In FIG. 1, a vacuum device 100 on which the cryopump 10 is mounted is shown in combination with the cryopump 10.

The vacuum device 100 includes a vacuum chamber 102 and a host controller 104 that controls the vacuum device 100. The vacuum device 100 may include an accelerator capable of generating radioactive rays (for example, a proton beam, a neutron ray, or the like), or may be a radiation therapy device.

The cryopump 10 includes a cryopump main body 12 and a cryocooler 14. The cryocooler 14 includes a cold head 16 and a compressor 18. The cold head 16 includes a cold head motor 16a that drives the cold head 16.

The cryopump main body 12 is attached to the vacuum chamber 102 of the vacuum device 100 and is used to increase the degree of vacuum of the vacuum chamber 102 to a level required for a desired vacuum process. A cryogenic temperature surface (not shown) which is also referred to as a cryopanel is accommodated in the cryopump main body 12. A gas that enters from an intake port of the cryopump main body 12 is captured by condensation or adsorption on the cryogenic temperature surface. Since the configuration of the cryopump main body 12 such as a disposition and a shape of the cryopanel can adopt various known configurations as appropriate, the configuration will not be described in detail here.

The compressor 18 of the cryocooler 14 is configured to recover a working gas of the cryocooler 14 from the cold head 16, to pressurize the recovered working gas, and to supply the working gas to the cold head 16 again. The working gas is usually a helium gas, but appropriate other gases may be used.

The cryocooler 14 includes a high pressure line 20a and a low pressure line 20b. The high pressure line 20a connects the compressor 18 to the cold head 16 such that a high pressure working gas compressed by the compressor 18 is supplied from the compressor 18 to the cold head 16. The low pressure line 20b connects the compressor 18 to the cold head 16 such that a low pressure working gas decompressed by expansion in the cold head 16 is recovered from the cold head 16 to the compressor 18. The cold head 16 is also called an expander of the cryocooler 14.

A circulation circuit of the working gas, that is, a refrigeration cycle of the cryocooler 14 is constituted by the cold head 16, the compressor 18, and the high pressure line 20a and the low pressure line 20b connecting the cold head 16 and the compressor 18 to each other, and a cooling stage of the cold head 16 is cooled. The cryopanel is attached to the cooling stage of the cold head 16, and the cryopanel is also cooled by the cooling of the cold head 16. The cryocooler 14 is, for example, a two-stage Gifford-McMahon (GM) cryocooler, but may be another type of cryocooler.

In addition, the cryopump 10 includes a control device including a cryopump controller 30, an input/output unit (hereinafter, also referred to as an I/O device 32), and a converter 34.

The cryopump controller 30 is configured to control the cryopump 10 based on a command received from the host controller 104 or autonomously. In addition, the cryopump controller 30 is configured to transmit information on the cryopump 10 to the host controller 104. The cryopump controller 30 is connected to the cryopump main body 12 to communicate with each other via the I/O device 32, and is connected to the compressor 18 to directly communicate with the compressor 18.

The I/O device 32 may be, for example, an I/O module or a remote I/O unit, and includes an I/O circuit 32a. The I/O circuit 32a is connected between the cryopump main body 12 and the cryopump controller 30, and is configured to aggregate transmission and reception between the cryopump main body 12 and the cryopump controller 30. The I/O circuit 32a is connected to each device to transmit and receive a signal to and from various electrical components (for example, temperature sensors, pressure sensors, and valves) including the cold head motor 16a which are provided in the cryopump main body 12.

In addition, the I/O device 32 includes an inverter 32b that controls the cold head motor 16a. The cold head motor 16a is supplied with power from a power supply 40 such as a commercial power supply (three-phase AC power supply) via the inverter 32b. The cold head motor 16a may be an electric motor that varies an operation frequency (that is, the number of revolutions of the cold head motor 16a), and can operate at an operation frequency corresponding to an output frequency of the inverter 32b. The operation frequency of the cold head motor 16a determines the number of times of a heat cycle (in a case where the cryocooler 14 is a GM cryocooler, a GM cycle) performed in the cold head 16 per unit time, that is, a frequency of the heat cycle. As an example, the output frequency of the inverter 32b (that is, the operation frequency of the cold head motor 16a) may vary in a range of 30 Hz to 100 Hz or in a range of 40 Hz to 70 Hz.

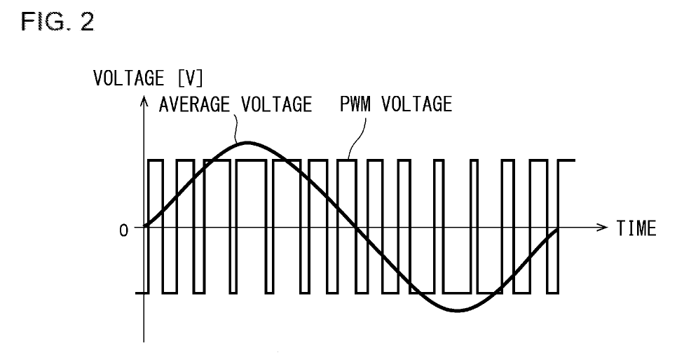

FIG. 2 is a view schematically illustrating an example of a control output from the inverter 32b to the cold head motor 16a according to the embodiment. The inverter 32b is configured to generate a pulse width modulation (PWM) voltage by PWM control from an input voltage from the power supply 40 and output the PWM voltage to the cold head motor 16a. The inverter 32b may implement known PWM control.

In a waveform of the PWM voltage output from the inverter 32b, as shown in FIG. 2, a duty ratio of each pulse of the PWM voltage waveform is adjusted by the inverter 32b such that a time-averaged voltage of the PWM voltage has a sinusoidal waveform having the operation frequency determined by the cryopump controller 30. Therefore, when the PWM voltage is input from the inverter 32b to the cold head motor 16a, the cold head motor 16a can be driven at the operation frequency determined by the cryopump controller 30.

The cryopump controller 30 may determine the operation frequency of the cold head motor 16a such that the cooling temperature of the cryopanel in the cryopump main body 12 follows a target temperature value, and control the inverter 32b such that the cold head motor 16a operates at the determined operation frequency.

For example, the cooling temperature of the cryopanel may be measured by a temperature sensor provided in the cryopump main body 12, and the cryopump controller 30 may acquire a measured temperature signal indicating a measured temperature from the temperature sensor via the I/O circuit 32a. The cryopump controller 30 may determine the output frequency of the inverter 32b by feedback control to minimize a deviation between the measured temperature and the target temperature value. The cryopump controller 30 may determine the output frequency of the inverter 32b as a function of the deviation between the measured temperature and the target temperature value (for example, by PID control). The cryopump controller 30 may transmit a motor control signal representing the determined output frequency of the inverter 32b to the I/O device 32. The inverter 32b may generate the PWM voltage in accordance with the motor control signal and output the PWM voltage to the cold head motor 16a.

An internal configuration of the cryopump controller 30 and the I/O device 32 is realized by elements and circuits such as a CPU and a memory of a computer as a hardware configuration, and is realized by a computer program as a software configuration. However, in the drawings, the internal configuration is appropriately illustrated as a functional block realized by cooperation of the elements and the circuits. It is clear for those skilled in the art that the functional blocks can be realized in various manners in combination with hardware and software.

In a case where the vacuum device 100 can generate radioactive rays from the vacuum chamber 102 during operation, the vacuum chamber 102 is disposed in a radiation management area or radiation controlled area 106. The cryopump main body 12 is also disposed in the radiation management area 106 in combination with the vacuum chamber 102 of the vacuum device 100. The cold head motor 16a is disposed in the radiation management area 106 since the cold head motor 16a is a part of the cryopump main body 12. The radiation management area 106 is set in advance around the vacuum chamber 102 as an area where a radiation dose exceeding a reference value may be generated, and entry of a person into this area is restricted at least during the operation of the vacuum device 100. To prevent the radioactive rays that can be generated in the vacuum chamber 102 from being leaked to the outside, the radiation management area 106 may be surrounded by a radiation blockade wall 108 having a relatively large thickness such as a concrete wall or a lead wall, and may be partitioned from a safe area outside the radiation blockade wall 108.

Incidentally, in an existing cryopump, there is a design in which at least a part of the control device of the cryopump 10 is directly attached to the cryopump main body 12, for example, by screwing a casing of the cryopump controller 30 and/or a casing of the I/O device 32 to an outer surface of the cold head 16. In this case, the control device of the cryopump 10 is disposed in the radiation management area 106 in combination with the cryopump main body 12, and can receive radioactive rays with a radiation dose exceeding the reference value during the operation of the vacuum device 100. The radioactive rays may have an adverse effect such as a malfunction or damage on the control device.

To protect the cryopump 10 from radioactive rays that may be generated in the vacuum chamber 102, the control device of the cryopump 10 may be disposed remotely from the cryopump main body 12, preferably outside the radiation management area 106. The cryopump controller 30 and the I/O device 32 may be disposed outside the radiation management area 106. Note that the compressor 18 may also be disposed outside the radiation management area 106. The host controller 104 of the vacuum device 100 may also be disposed outside the radiation management area 106.

In this way, the inverter 32b may be disposed remotely from the cold head motor 16a and may be disposed outside the radiation management area 106. The inverter 32b may be connected to the cold head motor 16a by a power cable 36. The power cable 36 may include a core wire for transmitting power and an electromagnetic shield surrounding the core wire, and the electromagnetic shield may be grounded.

For example, the power cable 36 may have a length of 1 m or more, 5 m or more, or 10 m or more. In addition, the power cable 36 may have, for example, a length of 100 m or less, or 50 m or less, or 20 m or less. In this way, the power cable 36 can have a length sufficient to connect the inverter 32b and the cold head motor 16a, which are separated by the radiation blockade wall 108 and are disposed at a relatively long distance.

However, the present inventor has found through experiments that when the inverter 32b is disposed remotely from the cold head motor 16a and is simply connected by the power cable 36, the cold head motor 16a cannot be operated at a determined operation frequency or an undesirable phenomenon such as the cold head motor 16a not moving at all can be observed.

One cause is considered to be that the adverse effect of a leakage current becomes non-negligible. For example, the leakage current may be generated in the electromagnetic shield of the power cable 36. A waveform of the PWM voltage transmitted through the power cable 36 may be disturbed due to the influence of the leakage current, and the waveform may not have an assumed shape when input to the cold head motor 16a.

Alternatively, the cause may be based on a specification of the inverter 32b. The inverter 32b may be configured to detect normal operation (that is, operation at a determined operation frequency) of the cold head motor 16a. The inverter 32b may be configured to increase a supply current to the cold head motor 16a until the normal operation of the cold head motor 16a is detected. In this case, when the cold head motor 16a does not operate normally, an overcurrent may cause the inverter 32b and the cold head motor 16a to stop operating.

Therefore, in the embodiment, as illustrated in FIG. 1, the converter 34 is connected between the inverter 32b and the cold head motor 16a. The converter 34 is disposed outside the radiation management area 106 as in the I/O device 32. The converter 34 is connected to the cold head motor 16a by the power cable 36 described above.

The converter 34 is disposed closer to the inverter 32b as compared with the cold head motor 16a. The converter 34 and the inverter 32b may be connected to each other by a power cable 38 shorter than the power cable 36. Alternatively, the converter 34 may be integrated with the I/O device 32 and may constitute a part of the I/O device 32. The inverter 32b and the converter 34 are disposed close to each other, and thus it is possible to suppress disturbance of the PWM voltage waveform between the inverter 32b and the converter 34.

The converter 34 is configured to receive the PWM voltage from the inverter 32b, convert the PWM voltage into a cold head motor drive voltage, and output the cold head motor drive voltage to the cold head motor 16a. The cold head motor drive voltage is configured to drive the cold head motor 16a at a determined operation frequency (that is, the operation frequency of the cold head motor 16a indicated by the PWM voltage). Therefore, when the cold head motor drive voltage is input from the converter 34 to the cold head motor 16a, the cold head motor 16a can be driven at the determined operation frequency.

However, the cold head motor drive voltage has a waveform in which a radio frequency component is reduced as compared with the PWM voltage. Therefore, the converter 34 may include a low-pass filter that removes or reduces the radio frequency component from the PWM voltage. For example, the radio frequency component to be reduced may be a frequency component exceeding the operation frequency of the cold head motor 16a determined by the cryopump controller 30, a frequency component exceeding twice the operation frequency of the cold head motor 16a determined by the cryopump controller 30, or a frequency component exceeding five times the operation frequency of the cold head motor 16a determined by the cryopump controller 30.

As an exemplary configuration, the converter 34 may include a sinusoidal filter. The sinusoidal filter converts the PWM voltage into a cold head motor drive voltage such that the cold head motor drive voltage has a sinusoidal waveform having the determined operation frequency. In other words, the sinusoidal filter converts the PWM voltage into a time-averaged voltage shown in FIG. 2, and outputs the time-averaged voltage to the cold head motor 16a as the cold head motor drive voltage. The sinusoidal filter may be, for example, a known sinusoidal filter including an LC circuit or an LCR circuit.

It is considered that the above-described leakage current becomes remarkable as more of the radio frequency components are included in the PWM voltage. According to the embodiment, since the cold head motor drive voltage has a waveform in which the radio frequency component is reduced as compared with the PWM voltage, the influence of the leakage current is reduced or can be ignored. Therefore, the above-described problem can be solved, and the cold head motor 16a can be operated at the determined operation frequency. The control device of the cryopump 10 can be disposed outside the radiation management area 106, and the adverse effect of the radioactive rays on the control device is also reduced or prevented. In this way, the cryopump 10 can be adapted to the radiation environment.

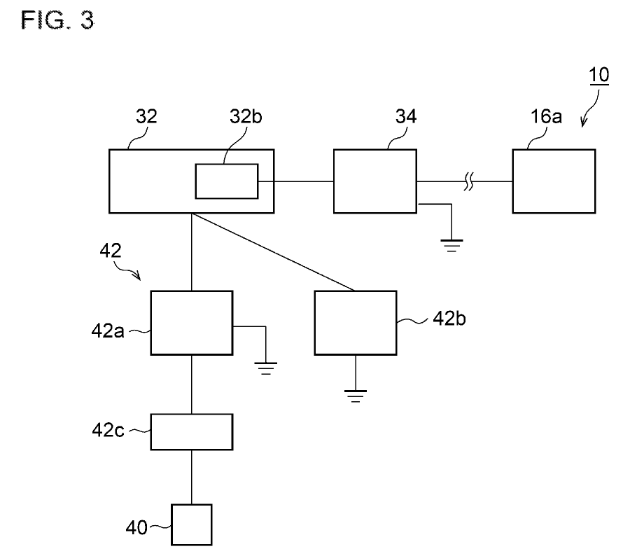

FIG. 3 is a view schematically illustrating a part of the control device of the cryopump 10 according to the embodiment. The cryopump 10 may further include at least one noise reduction component 42 provided between the inverter 32b and the power supply 40 of the inverter 32b. Various known noise reduction components can be adopted as the noise reduction component 42. As an example, the noise reduction component 42 may include a noise filter 42a such as an LC filter and a line noise filter such as a radio noise filter 42b. The noise reduction component 42 may include a ferrite core 42c. In this way, it is possible to reduce a noise such as a common mode noise and stably operate the control device of the cryopump 10 such as the I/O device 32.

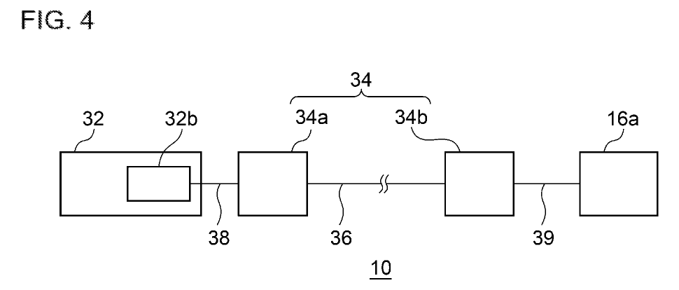

FIG. 4 is a view schematically illustrating a part of the control device of the cryopump 10 according to the embodiment. The converter 34 may include a first converter 34a and a second converter 34b. The first converter 34a may be disposed close to the inverter 32b, and the second converter 34b may be disposed close to the cold head motor 16a. The first converter 34a and the second converter 34b may be connected to each other by the power cable 36 described above. The first converter 34a and the inverter 32b may be connected by the power cable 38 shorter than the power cable 36, and the second converter 34b and the cold head motor 16a may be connected by a power cable 39 shorter than the power cable 36.

The first converter 34a is configured to receive the PWM voltage from the inverter 32b and convert the PWM voltage into an intermediate voltage. The intermediate voltage has a waveform in which the radio frequency component is reduced as compared with the PWM voltage. The second converter 34b is configured to receive the intermediate voltage from the first converter 34a, convert the intermediate voltage into the cold head motor drive voltage, and output the cold head motor drive voltage to the cold head motor 16a. For example, the intermediate voltage may be a DC voltage, the first converter 34a may be an AC-DC converter that converts the PWM voltage into the intermediate voltage (DC voltage), and the second converter 34b may be a DC-AC converter that converts the intermediate voltage (DC voltage) into an AC voltage for driving the cold head motor 16a. Even in this way, the cold head motor 16a can be operated at the determined operation frequency as in the embodiment described with reference to FIG. 1.

The present invention has been described hereinbefore based on the examples. It will be understood by those skilled in the art that the present invention is not limited to the embodiment, various design changes and modification examples are possible, and such modification examples are also within the scope of the present invention. Various features described concerning a certain embodiment are also applicable to other embodiments. New embodiments resulting from combinations have the effect of each of embodiments which are combined.

In the above-described embodiment, a case where the cryopump 10 includes one cryopump main body 12 has been described as an example. However, the cryopump 10 may include a plurality of cryopump main bodies 12, for example, several to several tens of cryopump main bodies 12, or more than that. In addition, a plurality of the compressors 18 may be provided in the cryopump 10 to supply and discharge a refrigerant gas to and from the cold head 16 of the cryopump main body 12.

In the above-described embodiment, a case where the vacuum device 100 is the radiation therapy device has been described as an example. However, the vacuum device 100 may be a device for other uses. For example, the vacuum device 100 may be a vacuum process device such as an ion implanter, a sputtering device, and a vapor deposition device configured to process a workpiece such as a wafer in a vacuum environment inside the vacuum chamber 102 with a desired vacuum process.

In the above-described embodiment, a case where the present invention is applied to the cryopump has been described as an example. However, the present invention may be applied to a cryocooler instead of the cryopump. In a certain embodiment, the cryocooler may include a cold head motor, an inverter that is disposed remotely from the cold head motor and is configured to output a PWM voltage for driving the cold head motor at a determined operation frequency, and at least one converter connected between the inverter and the cold head motor. The converter may be configured to receive a PWM voltage from the inverter, convert the PWM voltage into a cold head motor drive voltage that drives the cold head motor at a determined operation frequency, and output the cold head motor drive voltage to the cold head motor. The cold head motor drive voltage may have a waveform in which the radio frequency component is reduced as compared with the PWM voltage.

Although the present invention has been described using specific phrases based on the embodiments, the embodiments merely show one aspect of the principles and applications of the present invention, and many modification examples and changes in disposition are allowed without departing from the scope of the present invention defined in the appended claims.

It should be understood that the invention is not limited to the above-described embodiment, but may be modified into various forms on the basis of the spirit of the invention. Additionally, the modifications are included in the scope of the invention.

What is claimed is:

1. A cryopump comprising:
a cold head motor;
an inverter that is disposed remotely from the cold head motor and is configured to output a pulse width modulated (PWM) voltage for driving the cold head motor at a determined operation frequency; and
at least one converter that is connected between the inverter and the cold head motor, the at least one converter being configured to:
receive the PWM voltage from the inverter,
convert the PWM voltage into a cold head motor drive voltage for driving the cold head motor at the determined operation frequency, and
output the cold head motor drive voltage to the cold head motor,
wherein the cold head motor drive voltage has a waveform in which a radio frequency component is reduced as compared with the PWM voltage.

2. The cryopump according to claim 1,
wherein the at least one converter includes a sinusoidal filter that converts the PWM voltage into the cold head motor drive voltage, and
the cold head motor drive voltage has a sinusoidal waveform having the determined operation frequency.

3. The cryopump according to claim 2,
wherein the sinusoidal filter is disposed closer to the inverter as compared with the cold head motor.

4. The cryopump according to claim 2,
wherein the sinusoidal filter is connected to the cold head motor by a power cable having a length of 1 m to 100 m.

5. The cryopump according to claim 2,
wherein the cold head motor is disposed in a radiation management area, and
the inverter and the sinusoidal filter are disposed outside the radiation management area.

6. The cryopump according to claim 1,
wherein the at least one converter includes:
a first converter configured to receive the PWM voltage from the inverter and convert the PWM voltage into an intermediate voltage, and
a second converter configured to receive the intermediate voltage from the first converter, convert the intermediate voltage into the cold head motor drive voltage, and output the cold head motor drive voltage to the cold head motor, and
the intermediate voltage has a waveform in which a radio frequency component is reduced as compared with the PWM voltage.

7. The cryopump according to claim 6,
wherein the intermediate voltage is a DC voltage.

8. The cryopump according to claim 1, further comprising:
a noise reduction component provided between the inverter and a power supply of the inverter.

9. A control device comprising:
an inverter that is disposed remotely from a cold head motor and is configured to output a pulse width modulated (PWM) voltage for driving the cold head motor at a determined operation frequency; and
at least one converter that is connected between the inverter and the cold head motor, the at least one converter being configured to:
receive the PWM voltage from the inverter,
convert the PWM voltage into a cold head motor drive voltage for driving the cold head motor at the determined operation frequency, and
output the cold head motor drive voltage to the cold head motor,
wherein the cold head motor drive voltage has a waveform in which a radio frequency component is reduced as compared with the PWM voltage.
